(19) United States
(12) Patent Application Publication
(10) Pub. No.: US 2007/0147800 A1
(43) Pub. Date: Jun. 28, 2007

(54) Disk reproduction apparatus and content reproduction method

(75) Inventor: Masaki Nakagawa, Sagamihara-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/645,571

(22) Filed: Dec. 27, 2006

(30) Foreign Application Priority Data
Dec. 28, 2005 (JP) 2005-378544

(51) Int. Cl. H04N 5/00

(52) U.S. Cl. 386/125

(57) ABSTRACT

According to one embodiment, a disk reproduction apparatus featured by downloading additive contents from a supply source of contents of a disk at a time point at which the disk has been set, and then, storing the downloaded additive contents in a predetermined storage section, detecting a first play list that is a play list of contents recorded in the disk and a second play list that is a play list of the additive contents stored in the storage section, and then, generating each one of the play lists, and reproducing in a reproduction sequence of contents specific to an optical disk the latest contents among the contents of each one of the first play list and the second play list.

### CROSS-REFERENCE TO RELATED APPLICATIONS

This application is based upon and claims the benefit of priority from Japanese Patent Application No. 2005-378544, filed Dec. 28, 2005, the entire contents of which are incorporated herein by reference.

### BACKGROUND

1. Field

One embodiment of the invention relates to a disk reproduction apparatus and a content reproduction method in the disk reproduction apparatus for, when contents are reproduced from a medium in which the contents are stored, reproducing additive contents acquired via a network by means of an arbitrary number of devices connected via the network.

2. Description of the Related Art

It has been long since optical disks were practically available as recording mediums capable of retaining video image contents or audio contents with high density.

Optical disks are rapidly becoming prevalent, since they are capable of reproduction of contents from an arbitrary reproduction position, and have large recording capacity with respect to a physical magnitude, as compared with a tape shaped medium.

In recent years, there have been also already practically used ultra high-density optical disks (High Definition Digital Versatile Disc, hereinafter, referred to as HD DVD) capable of storing HD-standard video image data and high quality sound audio data in one disk by utilizing a blue or violet laser light beam with a short wavelength for reproduction of recorded contents (information).

In HD DVD standard optical disks (including some of the DVD standard optical disks), address or link destination information for recommending access to a supplier's of contents via a network is included in one of the contents stored in an optical disk.

Thus, in the case of reproducing an optical disk in a disk reproduction apparatus, additive contents which a content supplier's provides are downloaded from a network, thereby enabling reproduction simultaneously and/or in parallel. On the other hand, in the case where additive contents have been downloaded a plurality of times using two or more disk reproduction apparatuses, it may be unknown by which download the contents have been obtained as the latest play list.

Japanese Patent Application Publication (KOKAI) No. 2004-37981, there has been reported an example of, with respect to downloaded contents in a main unit called a home server, enabling transfer to a children machine permitted for reproduction of contents downloaded by the server.

As described above, when reproducing an HD DVD disk, additive contents are downloaded in accordance with address or link destination information for recommending an access to a supply source of contents stored in an optical disk, whereby it may be unknown by which download the contents have been obtained as the latest play list. In addition, of course, it is preferred to reproduce the contents stored in the HD DVD disk in accordance with the latest play list including the downloaded additive contents.

In the Patent Application Publication (KOKAI) No. 2004-37981, there is no disclosure of reproduction in accordance with the latest play list including the additive contents downloaded from a content supply source.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary diagram showing an example of a disk reproduction apparatus according to an embodiment of the invention;

FIG. 2 is an exemplary diagram showing an example of a play list produced in the disk reproduction apparatus shown in FIG. 1, according to an embodiment of the invention;

FIG. 3 is an exemplary diagram showing examples of display in the case where a user has changed a combination of play lists from the play list shown in FIG. 2, according to an embodiment of the invention;

FIG. 4 is a flowchart showing an example of procedures for changing the play list shown in FIG. 3 to produce the latest play list, according to an embodiment of the invention;

FIG. 5 is an exemplary diagram showing an example of another embodiment of the disk reproduction apparatus shown in FIG. 1, according to an embodiment of the invention;

FIG. 6 is an exemplary diagram showing an example of display in the case where a user has changed a combination of play lists from the play list shown in FIG. 5, according to an embodiment of the invention;

FIG. 7 is an exemplary diagram showing an example of display in the case where there occurs a change restriction on reproduction order by an HD DVD disk supply source with respect to the user-produced play list as shown in FIG. 6, according to an embodiment of the invention;

FIG. 8 is an exemplary diagram showing an example of constructing the latest play list by referring to all the play lists in the case where a plurality of disk reproduction apparatuses including substantially identical functions are connected in a closed network, and then, additive contents have been downloaded from a web site of an HD DVD disk supply source a plurality of times or at separate timings by means of arbitrary disk reproduction apparatuses, according to an embodiment of the invention;

FIG. 9 is an exemplary diagram showing an example of a play list in the case of reproducing additive (downloaded) contents maintained in P-storage of each one of a plurality of disk reproduction apparatuses shown in FIG. 8 by using the disk reproduction apparatus currently used for reproducing an HD DVD, according to an embodiment of the invention;

FIG. 10 is a flowchart showing an example of a screen having displayed thereon procedures for selectively capturing additive contents maintained independently in a plurality of disk reproduction apparatuses shown in FIG. 8, and then, producing the latest play list, according to an embodiment of the invention; and

FIG. 11 is a flowchart showing an example of procedures for selectively capturing additive contents maintained independently in a plurality of disk reproduction apparatuses shown in FIG. 8 in accordance with an instruction from a user, and then, producing the latest play list, according to an embodiment of the invention.

### DETAILED DESCRIPTION

Various embodiments according to the invention will be described hereinafter with reference to the accompanying drawings. In general, according to one embodiment of the invention, a disk reproduction apparatus featured by: downloading additive contents from a supply source of contents of a disk at a time point at which the disk has been set, and then, storing the downloaded additive contents in a predetermined storage section; detecting a first play list that is a play list of contents recorded in the disk and a second play list that is a play list of the additive contents stored in the storage section, and then, generating each one of the play lists; and reproducing in a reproduction sequence of contents specific to an optical disk the latest contents among the contents of each one of the first play list and the second play list.

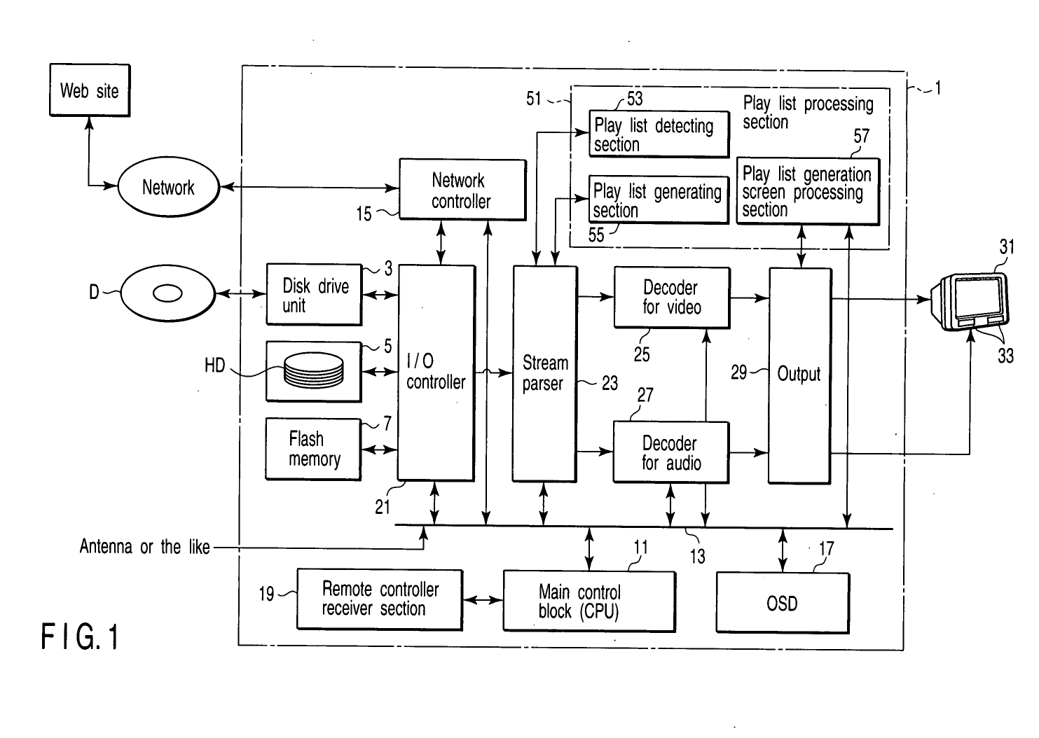

Embodiments of the invention will be explained in detail hereinafter with reference to the accompanying drawings. According to an embodiment, FIG. 1 schematically depicts an exemplary disk reproduction apparatus which is applicable in embodiments of the present invention.

An embodiment of the present invention is directed to a disk reproduction apparatus capable of reproducing contents in accordance with the latest play list together with additive contents stored in an HD DVD disk and downloaded additive contents in accordance with the latest play list including additive contents downloaded from an external server. In addition, an embodiment of the present invention is directed to a disk reproduction method capable of reproducing contents in accordance with the latest play list together with additive contents stored in an HD DVD disk and downloaded additive contents in accordance with the latest play list including additive contents downloaded from an external server.

A disk reproduction apparatus 1 shown in FIG. 1 has: a disk drive unit 3 capable of reproducing information stored in an optical disk D by setting a recording medium, for example, an HD standard DVD disk (hereinafter, referred to as an HD DVD disk) D; a hard disk drive (HDD) unit 5 including a hard disk HD used as Persistent Storage (hereinafter, referred to as P-storage); and a semiconductor memory that is a nonvolatile memory similarly used as P-storage, for example, a flash memory 7 or the like. It is sufficient as long as the P-storage having a capacity of 128 megabytes (M Bytes) or more is provided, and at least one of the HDD 5 and the flash memory 7 is provided.

The disk drive unit 3, the hard disk drive unit 5, and the flash memory 7 are connected to a main control bloc 11 including a CPU via a data bus 13 and an I/O controller 21. The data retained in the HD DVD disk D, the HDD 5, and the flash memory 7 or the like is formed in a data format called well known packetized stream (hereinafter, referred to as “PS”). In addition, although not described in detail, in the case of an HD DVD recorder, it is possible to perform image recording (recording) of digital broadcast waves from terrestrial sites and satellites, the broadcast waves being received from a television tuner part (not shown) having a large capacity of HDD 5. Digital broadcasts are formed in a transport stream (hereinafter, referred to as TS) format.

In PS, video images (videos) and voices (audios) or other items of control data are multiplied in time division. Further, video images (videos) and voices (audios) are sent in a mode compressed for the purpose of reducing a data volume to be transmitted, respectively. In addition, a majority of data is provided as video data, and is compressed in accordance with standards called H. 264, VC1, or MPEG2, for example.

Data acquired via the I/O controller 21 is inputted to a stream parser 23 through a memory (D-RAM) (not shown), via the data bus 13. The inputted data is divided into video images, i.e., video signals and music (including voices), i.e., audio signals, and the separated signals are decoded by means of a decoder for video 25 and a decoder for audio 27, respectively, that correspond to these signals. The decoded video signals, i.e., video images are outputted to be displayable on a display device 31 represented by a liquid crystal display and a CRT, for example, through an output part 29. In addition, the decoded audio signals, i.e., music or voices are outputted from the output part 29 to a speaker 33.

A network controller 15 is also connected to the main control block 11 via the data bus 13.

The network controller 15 enables data delivery and transfer to an arbitrary number of disk reproduction apparatuses connected to an external server or over a LAN via a public communication line or a local area network (LAN). The external servers include a web site of a supplier's of an HD DVD disk, for example, and a distribution site or the like for distributing contents with charge. In addition, over the LAN, it is possible to connect a portable disk reproduction apparatus including substantially identical functions as those of the disk reproduction apparatus 1 or a disk reproduction apparatus in the same format provided in another location in home, for example, or in another format capable of reproducing an HD DVD disk D.

An on-screen display unit 17 and a remote controller receiver section 19 are also connected to the main control block 11 via the data bus 13. The on-screen display unit 17 is provided as a picture processing section for superimposing and displaying control information on an essential video signal for displaying a play list described below on the display device 31 or displaying an input command instructed from a user via the remote controller receiver section 19 on the display device 31.

A play list processing section 51, although described later in detail, includes a play list detecting section 53, a play list generating section 55, and a play list generation screen processing section 57.

Data captured via the I/O controller 21 is demultiplexed into a picture, i.e., a video signal, and music (including voice), i.e., an audio signal, by means of the stream parser 23 connected to the data bus 13, and then, the demultiplexed signals are decoded by means of the decoder for video 25 and the decoder for audio 27 that correspond thereto. The decoded video signal, i.e., picture is outputted so as to be displayable on the display device 31 represented by a liquid crystal display or CRT, for example, through the output section 29. In addition, the decoded audio signal, i.e., music or voice is outputted from the output section 29 to the speaker 33. The demultiplexed and decoded signals cannot be always identical to each other depending on those used for delivery to a viewer by means of the speaker 33 and those used for recording.

In the disk reproduction apparatus 1 shown in FIG. 1, in the case where commercially available HD DVD disk, i.e., video software is reproduced by setting them to the disk drive unit 3, it is possible to provide access to a web site of the supplier's of disks provided as address or link destination information for recommending access to the supplier's of contents stored in optical disks via the network controller 15.

By providing access to the web site being the disk supplier's provided in an HD DVD disk, it is possible to arbitrarily download additive contents represented by other language voices that are not stored in original programs or video software provided as video images added after video software has been manufactured, for example, as privileges for video software purchasers. As additive contents, for example, there exist contents called new guidance that is guidance of other video software supplied from the same supplier's, for example.

Additive contents acquired by downloading them are stored in a hard disk HD of the HDD unit 5 or the flash memory 7, for example.

Thus, in the case of reproducing optical disks in a disk reproduction apparatus, it is possible to reproduce contents stored in the HD DVD disks simultaneously or in parallel by downloading additive contents provided from content suppliers' via a network.

In the meantime, in an HD DVD disk, as described above, it is possible to provide an access to a web site of a supply source of a disk prepared as address or link destination information for recommending an access to a supply source of contents stored in an optical disk, via the network controller 15. Therefore, for example, in the case of downloading additive contents represented by a voice or the like of another language that is not stored in an original program or a video software prepared as a privilege to a purchaser of video software, for example, it is preferable that the additive contents obtained by such download can be reproduced at the same time or in parallel together with the contents stored in the HD DVD disk.

For example, in the case where a reproduction voice in accordance with a language that is not stored in a disk at the time of selling the HD DVD disk is distributed from a disk supply source, the reproduction voice in that language is downloaded, thereby enabling reproduction or the like in accordance with the downloaded language instead of the language stored in the HD DVD disk.

Namely, for example, in the case where two contents, cinema 1 and cinema 2 are recorded in voices of English and Korean, respectively, in the HD DVD disk (in the case where a voice of Japanese does not exist), the voices of Japanese are downloaded in P-storage, respectively. In this case, a new play list is recorded in P-storage. Therefore, at the time of reproduction, the cinema 1 and cinema 2 can be reproduced in the voices of Japanese. That is, a picture is outputted intact to the display device 21 with respect to cinema contents 1 and 2 reproduced from the HD DVD disk, whereas the downloaded voice maintained in P-storage is reproduced while synchronization is obtained. In this manner, at the time of sale, even in the HD DVD disk in which a voice of Japanese is not stored, the voice of Japanese is downloaded as additive contents from a supply source, thereby enabling reproduction using the voice of Japanese.

In addition, contents called new arrival guidance that is a guidance of other video software supplied by the same supply source, for example, also exist as additive contents supplied from a disk supply source. However, if time has elapsed from disk selling, there are often cases in which such guidance is a guidance of video software that has been already sold and purchased at a time point of reproducing the contents stored in the HD DVD disk.

Namely, for example, in the case where preview of cinema 1, preview of cinema 2, and preview of cinema 3 have been recorded as contents in the HD DVD disk, the previews of the respective cinemas become old information with an elapse of time. Thus, in the case where a predetermined time (years and months) has elapsed since the HD DVD disk was sold, for example, preview of cinema A, preview of cinema B, and preview of cinema C are downloaded in P-storage as new preview cinema contents.

By supplying such new contents, instead of preview of cinema 1, preview of cinema 2, and preview of cinema 3 stored in the HD DVD disk, preview of cinema A, preview of cinema B, and preview of cinema C can be reproduced as new preview cinema contents in accordance with a new play list maintained in P-storage.

In addition, for example, there are often cases in which a content supply source prepares original contents and partially added or edited contents not stored in the HD DVD disk, as a purchaser's privilege. Disk reproduction procedures considering these additive contents are generated by the apparatus when they are supplied or downloaded from a Web site as a new play list, and then, the procedures are stored in the P-storage described above.

In the disk reproduction apparatus 1 shown in FIG. 1, the data downloaded from a content supply source via the network controller 15 is stored in P-storage, i.e., a hard disk HD of the HDD 5 or the flash memory 7. At this time, the stored data is demultiplexed into a picture, i.e., a video signal, and music (including voice), i.e., an audio signal, in accordance with a new play list, via the stream parser 23 connected to the data bus 13, and the demultiplexed signals are supplied to the play list detecting section 53 and the play list generating section 55 of the play list processing section 51.

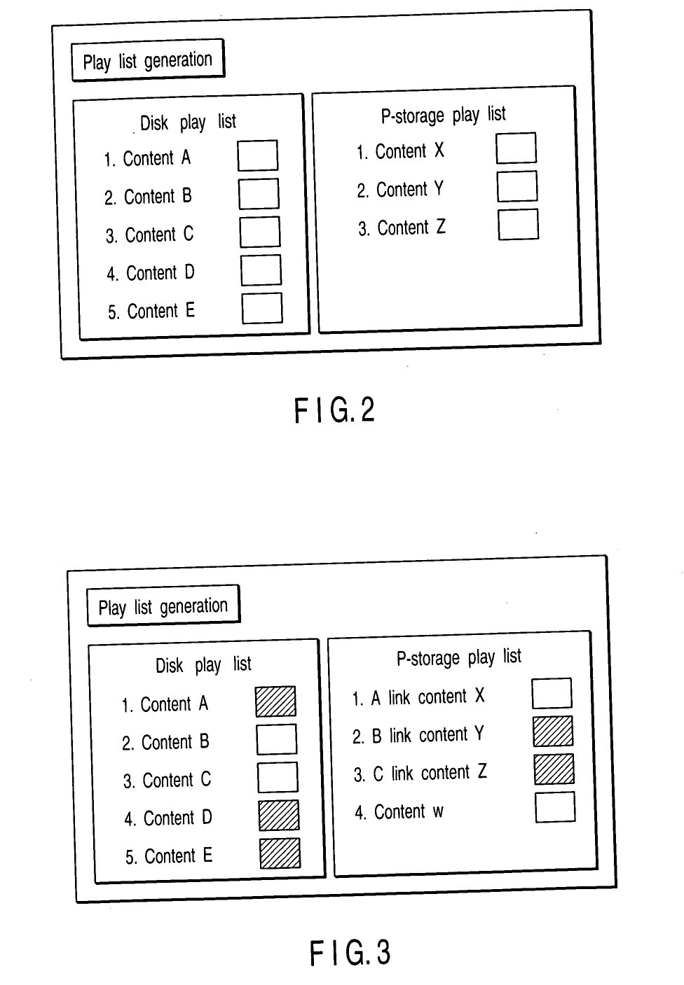

Therefore, two play lists as shown in FIG. 2 are displayed on the display device 31, for example, by means of the play list generating section 55. In FIG. 2, for example, there are displayed: a “disk play list” that is a play list of contents stored in the HD DVD disk; and a “P-storage play list” that is a play list of additive contents stored in P-storage by downloading them.

In this case, a user instructs reproduction sequences of an arbitrary play list from a remote controller terminal device, although not shown, for example, whereby the user set original play list reflecting the user's preference, is produced as shown in FIG. 3. FIG. 3 shows an example of a new play list for reproducing content B and content C by replacing them with content Y and content Z acquired by downloading them, from among contents A to E stored in the HD DVD disk. Of course, a new play list shown in FIG. 3 is outputted in a superimposed manner on a picture output forwarded from the output section 29 to the display device 31 by the OSD 17. In addition, the new play list shown in FIG. 3, is temporarily maintained in a nonvolatile memory (not shown), for example, in D-RAM, and is stored in the HDD unit 5 or in a predetermined region of the flash memory 7, for example, as required.

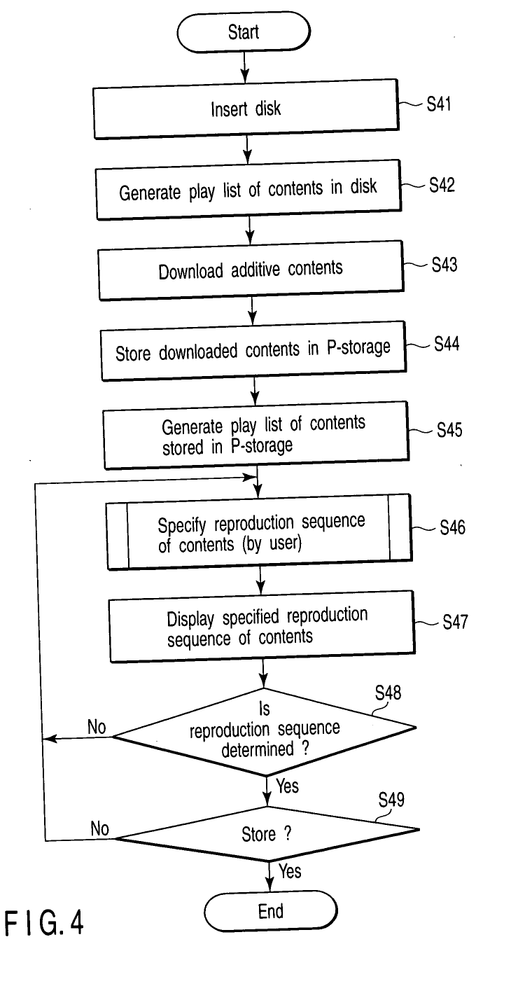

FIG. 4 shows an example of procedures for changing a play list shown in FIG. 3.

When an HD DVD is inserted into the disk drive unit 3 of the disk reproduction apparatus 1 (S41), a play list of contents stored in the HD DVD disk is produced or the play list is read out from the disk (S42).

Then, additive contents prepared in the corresponding HD DVD disk are downloaded from a manufacturer of the HD DVD disk or from a web site of content owner through the network controller 15 (S43), and then, are stored in P-storage (S44).

Next, a play list of (downloaded) additive contents stored in P-storage is generated or is downloaded from the Web site. The download sequence may be reversed from contents per se (S45). Steps S41 to S45 are substantially associated with those shown in FIG. 2.

Subsequently, the user instructs exchange between arbitrary contents stored in the HD DVD disk and additive contents maintained in P-storage, i.e., sequence for reproducing contents in accordance with time series (S46).

In accordance with time series, display inversion in the display device 31, for example, or highlight processing is carried out with respect to the contents whose reproduction sequences have been instructed in step S46 (S47). The state of step S47 corresponds to that shown in FIG. 3.

Then, it is checked whether or not to determine the reproduction sequence (S48). In the case where the check result is affirmative (Yes in S48), it is checked whether or not to store the setting, i.e., a “new play list” (S49). The determined settings, as described previously, are temporarily maintained in D-RAM (nonvolatile memory), although not shown, and a predetermined region of the hard disk HD of the HDD 5 or the flash memory 7 is allocated for storage of the determined settings.

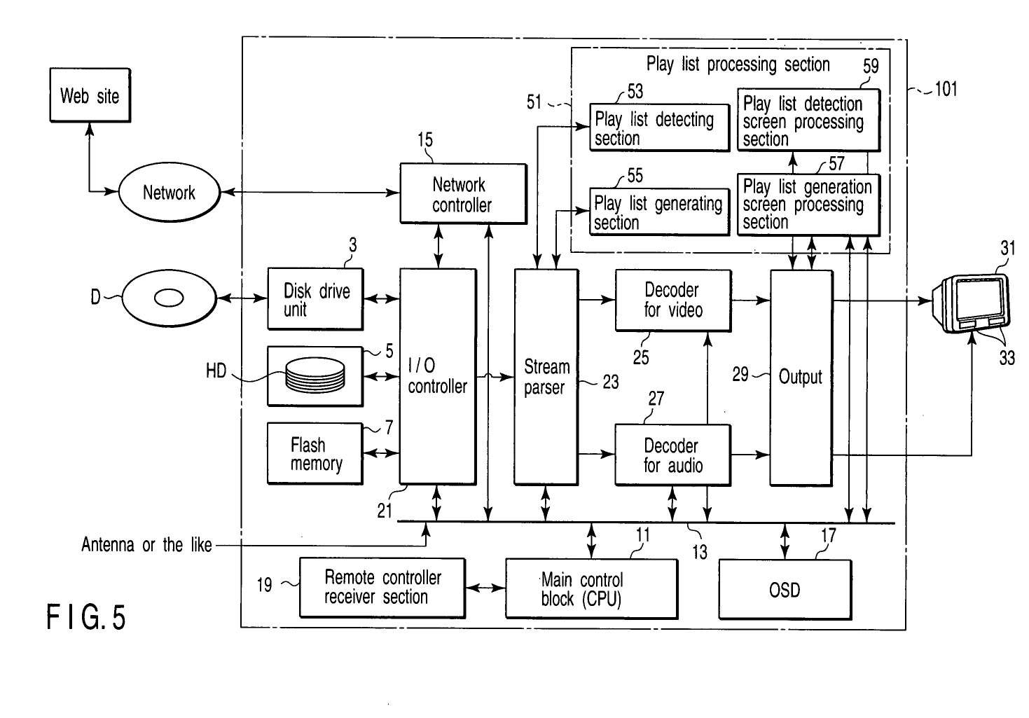

FIG. 5 shows an example of another embodiment of the disk reproduction apparatus shown in FIG. 1. Like elements or constituent elements shown in FIG. 1 are designated by like reference numerals. A detailed description thereof is omitted here.

A disk reproduction apparatus 101 shown in FIG. 5 is featured in that a play list detection screen processing section 159 has been added to the play list processing section 51 of the disk reproduction apparatus 1 shown in FIG. 1.

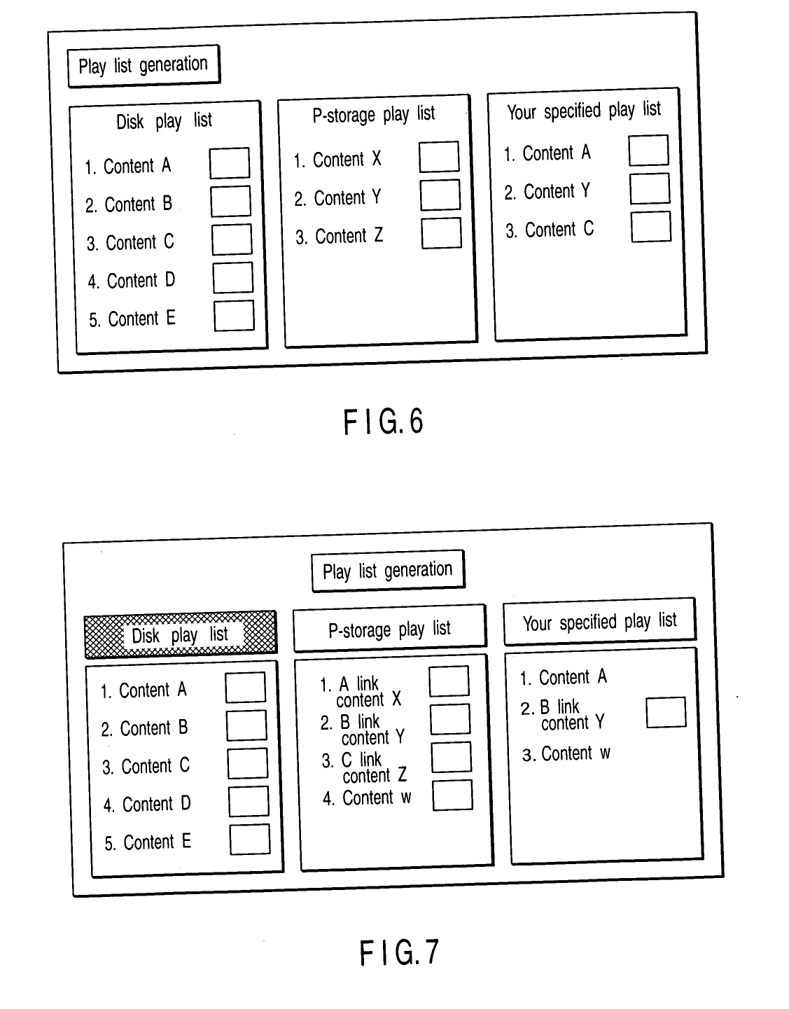

The play list detection screen processing section 59 is utilized as follows. That is, in the case where the user has set a new play list for reproducing content B by replacing it with content Y acquired by downloading, from contents A to E stored in the HD DVD disk, as FIG. 6 shows “your set play list”, for example, and as shown in FIG. 7, in the case where “your specified play list” that is a user-selected reproduction sequence cannot be executed due to the settings by the HD DVD disk supply source in which the preset content reproduction sequence cannot be changed, “your specified play list” is displayed and, for example, a “disk play list” is displayed in reverse video on a display section, thereby notifying that a play list change restriction exists.

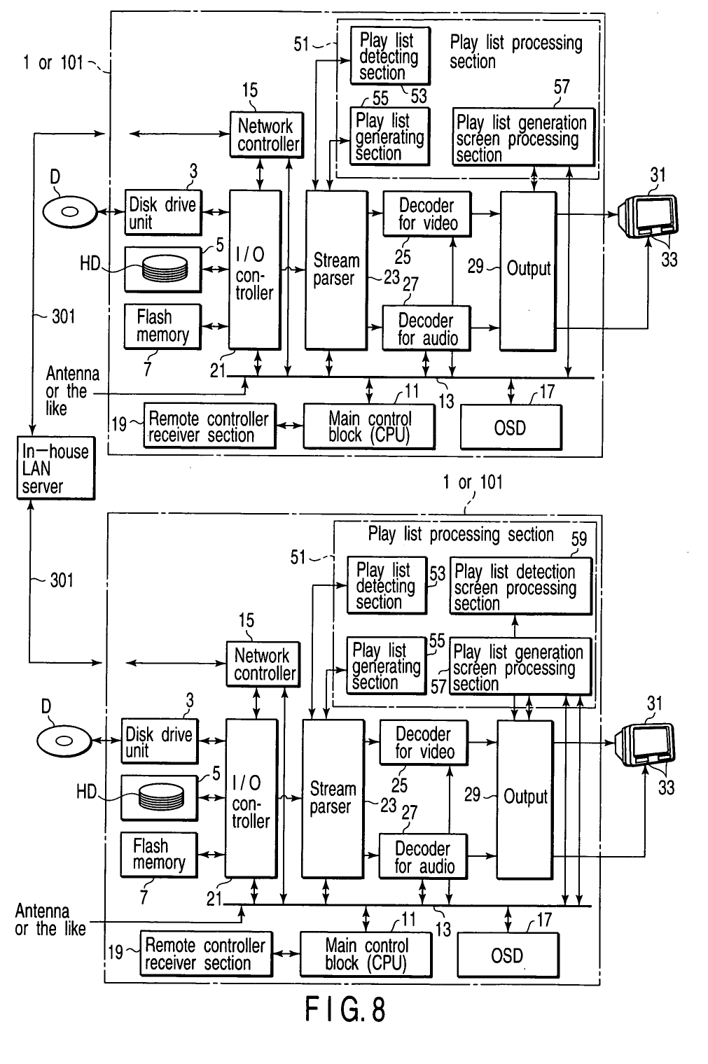

FIG. 8 shows an example of constructing the latest play list with reference to all of play lists in the case where there are connected: a portable disk reproduction apparatus including substantially identical functions of the disk reproduction apparatus 1 in a closed network such as an in-house LAN or in the case where, for example, a disk reproduction apparatus of the same type being provided in another location in house or that of another type capable of reproducing an HD DVD disk D, and then, additive contents are downloaded from a web site of an HD DVD disk supply source by means of an arbitrary disk reproduction apparatus a plurality of times or at separate timings. In FIG. 8, there is shown an example in which two substantially identical disk reproduction apparatuses 1 and 101 are connected to each other such that contents and play lists can be transferred to each other via an in-house LAN (server).

As has been described above, all the additive contents downloaded in P-storage of the disk reproduction apparatus 1 (HDD unit 5 or flash memory 7) can be reproduced when an HD DVD is reproduced in another disk reproduction apparatus (disk reproduction apparatus 101 in this case) existing on the LAN. In addition, conversely, additive contents downloaded independently by another disk reproduction apparatus 101 can be reproduced by means of the disk reproduction apparatus 1.

Thus, in each one of the disk reproduction apparatuses existing on the LAN, it is required that play lists of the additive contents stored in P-storage of all the disk reproduction apparatuses existing on the LAN can be read out by means of the disk reproduction apparatus currently utilized for reproduction of the HD DVD disk.

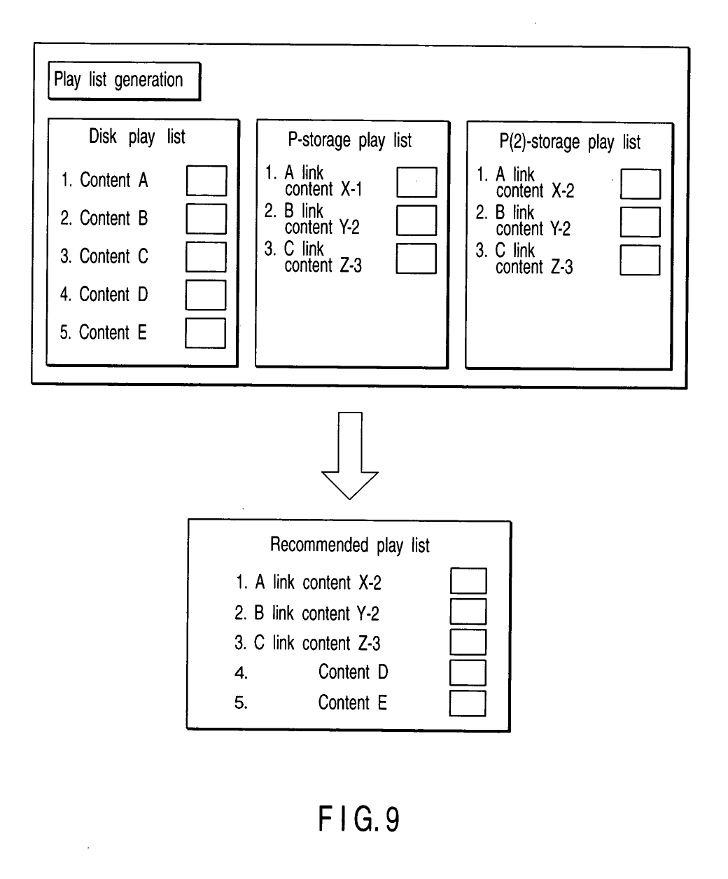

For example, as described below with reference to FIG. 9, in the case where the HD DVD disk D that is video software has been set in the disk reproduction apparatus 101, the play list maintained in P-storage of the disk reproduction apparatus 1 connected via the in-house LAN is detected by means of the play list detecting section 53 in the disk reproduction apparatus 101. In this case, the disk reproduction apparatus 1 connected via the LAN is started up (waken up) prior to the readout (detection) of the play list at a time point at which the HD DVD disk has been set in the disk reproduction apparatus 101.

Next, a play list generation screen is generated in the disk reproduction apparatus 101, and then, the generated screen is displayed on the display device 31 via the OSD 17. Although a play list to be detected may be a play list associated with a mounted disk, detection including a list that is not associated with a disk may be carried out as another embodiment.

FIG. 9 shows an example in which the fact that contents A to E stored in an HD DVD disk and contents X-1 (A link), Y-2 (B link), and Z-3 (C link) stored in P-storage of the disk reproduction apparatus 101 are stored in P-storage (101 side) is displayed as a “P-storage play list”. In addition, the fact that contents X-2 (A link), Y-2 (B link), and Z-3 (C link) are stored in P-storage (1 side) is displayed in P-storage of the disk reproduction apparatus 1 as “P (2)-storage play list”.

Therefore, as the latest play list, there may be formed a “recommended play list” for recommending that reproduction is carried out sequentially in order of content X-2 (A link) stored in P-storage (1 side); Y-2 (B link) stored in P-storage (101 side); Z-3 (C link); content D of the HV DVD disk; and content E of the HD DVD disk.

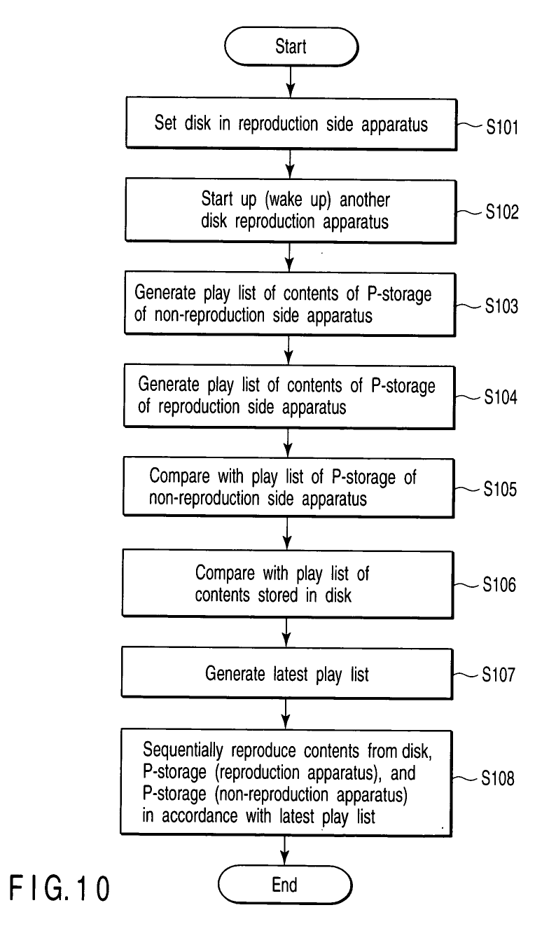

In more detail, as shown in FIG. 10, an HD DVD disk is set in the disk reproduction apparatus 101 (S101), whereby another disk apparatus (disk reproduction apparatus 1 in this case) existing on the LAN is started up (waken up) (S102); and then, a play list of the contents maintained in P-storage of the disk reproduction apparatus 1 is read out by means of the disk reproduction apparatus 101 (S103).

Next, a play list of the contents maintained in P-storage of the disk reproduction apparatus 101 is read out (S104), and then, the read out play list is compared with the play list read out from the disk reproduction apparatus 1 (S105).

Then, a play list maintained in each one of the disk reproduction apparatuses and a play list of the contents stored in the HD DVD disk are compared with each other sequentially in order (S106), and then, a play list from which the latest contents have been selected is generated (S107).

Subsequently, the latest contents including additive contents downloaded at an arbitrary timing are reproduced based on the generated latest play list (S108).

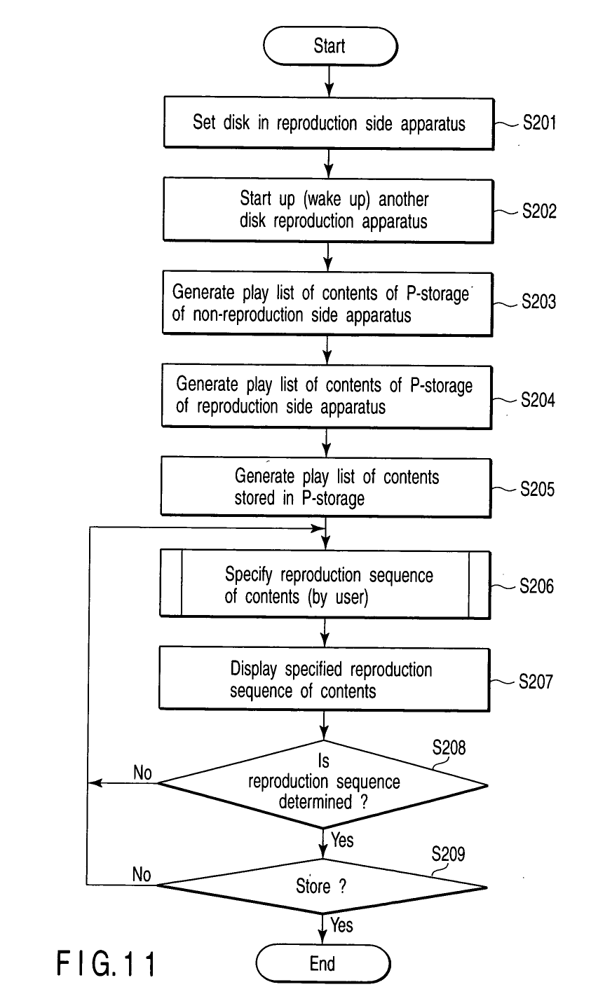

As shown in FIG. 11, as is the case with the example described previously with reference to FIG. 4, of course, an arbitrary reproduction sequence including downloaded additive contents, i.e., a user-specified play list can be produced.

That is, the HD DV disk is set in the disk reproduction apparatus 101 (S201), whereby another disk reproduction apparatus (disk reproduction apparatus 1 in this case) existing on the LAN is started up (waken up) (S202); and a play list of the contents maintained in P-storage of the disk reproduction apparatus 1 is read out by means of the disk reproduction apparatus 101 (S203).

Next, a play list of the contents maintained in P-storage of the disk reproduction apparatus 101 is read out (S204), and then, a play list of the (downloaded) additive contents stored in P-storage is generated (S205).

Subsequently, the user instructs exchange between arbitrary contents stored in the HD DVD disk and additive contents maintained in P-storage, i.e., sequence for reproducing contents in accordance with time series (S206).

In step S206, in accordance with time series, inversion or highlight processing of a display in the display device 31, for example, is carried out with respect to contents whose reproduction sequence has been instructed (S207).

Then, it is checked whether or not to determine the reproduction sequence (S208). In the case where the check result is affirmative (Yes in S208), it is checked whether or not to store the settings (S209). The determined settings are temporarily maintained in D-RAM (nonvolatile memory), although not shown, as described previously, and then, a predetermined region of the hard disk HD of the HDD 5, for example, is allocated for storage of the determined settings.

In this manner, in the case where there exist additive contents downloaded from a disk supply source when reproducing the contents stored in the HD DVD disk D, the latest play list is produced from the downloaded contents and the contents stored in the HD DVD disk; and then, in accordance with the produced play list, the latest contents together with the contents stored in the disk are reproduced by means of the disk reproduction apparatus.

As has been described above, according to an embodiment of the present invention, there can be provided a disk reproduction apparatus enabling reproduction reflecting a preferable reproduction sequence of the user and thus more suitable for the user preference. That is, in accordance with the latest play list including additive contents downloaded from an external server, it is possible to reproduce contents in accordance with the latest play list together with the contents stored in the HD DVD disk and the downloaded additive contents.

In addition, in the disk reproduction apparatus according to an embodiment of the present invention, the contents stored in the HD DVD disk and special contents supplied from a content supply source can be reproduced in accordance with the reproduction sequence or combination according to the user preference.

Further, in the case where there exist a plurality of additive contents downloaded independently in a closed network, for example, in each one of the disk reproduction apparatuses connected to the in-house LAN, the contents maintained in the individual disk reproduction apparatus can be reproduced by arbitrarily combining them.

The above-described disk reproduction apparatus 1 or disk reproduction apparatus 101 may be storage (storage device) of server type common to a closed network, i.e., to an intra-home LAN. In addition, as a network, a well-known wireless LAN is also available. In this case, at least one of the disk reproduction apparatuses shown in FIG. 8 can be employed as a mobile (portable) disk reproduction apparatus loaded on an automobile owned by a user.

In addition, as shown in FIG. 8, additive contents retained in P-storage of an arbitrary disk reproduction apparatus 1 (or 101) are read out by means of another disk reproduction apparatus 101 (or 1) situated over a LAN, and the contents stored in the set HD DVD disk D are reproduced together, as schematically shown in FIG. 6. Of course, this reproduction is achieved by connecting two disk reproduction apparatuses 101 (or 1) having substantially assigned thereto the similar functions to those of the disk reproduction apparatus 1 shown in FIG. 1 via an intra-home LAN, i.e., a closed network 301, making it possible to mutually transfer contents.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A disk reproduction apparatus comprising:
a disk unit which reads out contents recorded in an optical disk;
a data control unit which reads out, at a predetermined timing, the contents maintained in a storage in another location having maintained additive contents associated with the optical disk at a time point at which the optical disk has been set in the disk unit;
a nonvolatile memory which maintains the additive contents read out by means of the data control unit;
a play list processing section which detects a first play list that is a play list of the contents recorded in the optical disk and a second play list that is a play list of the additive contents maintained in the nonvolatile memory, and then, generates each one of the play lists; and
a reproduction control unit which instructs the play list processing section to produce a reproduction sequence.

2. The disk reproduction apparatus according to claim 1, wherein
the reproduction control unit which instructs the play list processing section to produce a reproduction sequence of contents from each one of the first play list and the second play list and a combination of the contents managed by the first and second play lists.

3. The disk reproduction apparatus according to claim 1, wherein
the reproduction control unit which instructs the play list processing section to enable reproduction of latest contents among the contents of each one of the first play list and the second play list in a reproduction sequence of contents specific to the optical disk.

4. The disk reproduction apparatus according to claim 1, wherein
the reproduction control unit which instructs the play list processing section to enable reproduction, in a predetermined reproduction sequence, of the contents recorded in the optical disk and the additive contents maintained in the nonvolatile memory, in accordance with any one of the first play list, the second play list, and a third play list having specified therein the reproduction sequence and a combination of contents from each one of the first play list and the second play list.

5. The disk reproduction apparatus according to claim 2, wherein the reproduction control unit causes the nonvolatile memory to store the reproduction sequence of the contents instructed for the play list processing section and the combination of the contents managed by the first and second play lists.

6. The disk reproduction apparatus according to claim 3, wherein the reproduction control unit causes the nonvolatile memory to store the reproduction sequence of the contents instructed for the play list processing section and the combination of the contents managed by the first and second play lists.

7. The disk reproduction apparatus according to claim 4, wherein the reproduction control unit causes the nonvolatile memory to store the reproduction sequence of the contents instructed for the play list processing section and the combination of the contents managed by the first and second play lists.

8. A disk reproduction apparatus comprising:
a data control unit which downloads additive contents from a supply source of contents of an optical disk at a time point at which the optical disk has been set in a disk drive unit;
a first storage unit which maintains the downloaded additive contents in a device different from a device having the disk drive unit stored therein;
a second storage unit which maintains the downloaded additive contents in a device having the disk drive unit stored therein;
a play list processing section which detects a first play list that is a play list of the contents stored in the optical disk, a second play list that is a play list of the contents maintained in the first storage unit, and a third play list that is a play list of the contents maintained in the second storage unit, respectively, and then, generates each one of the play lists; and
a reproduction control unit which causes the play list processing section to detect latest contents among the contents managed by the first to third play lists, and reproduce the detected contents in a reproduction sequence of contents stored in the optical disk.

9. The disk reproduction apparatus according to claim 8, wherein the device having the disk drive unit stored therein starts up the device different from the device having the disk drive unit stored therein at a time point at which an optical disk has been set in the disk drive unit, and then, reads out the second play list maintained in the second storage unit.

10. A content reproduction method comprising:
downloading additive contents from a supply source of contents of an optical disk at a time point at which the optical disk has been set;
storing the downloaded additive contents in a predetermined storage section;
detecting a first play list that is a play list of contents recorded in the optical disk and a second play list that is a play list of the additive contents stored in the storage section, and then, generating each one of the play lists;
instructing production of a reproduction sequence of contents from each one of the first play list and the second play list and a combination of contents managed by the first and second play lists; and
reproducing, in a reproduction sequence of contents specific to the optical disk, at least one of latest contents among the contents of each one of the first play list and the second play list and the contents stored in the optical disk and the downloaded additive contents together.

11. The content reproduction method according to claim 10, further comprising:
specifying a content reproduction sequence so as to enable reproduction, in a predetermined reproduction sequence, of the contents stored in the optical disk and the additive contents maintained in the storage section, in accordance with any one of the first play list, the second play list and a third play list having specified therein a reproduction sequence of contents and a combination from each one of the first play list and the second play list.

12. The content reproduction method according to claim 10, further comprising:
reading out a play list of additive contents downloaded on the disk unit in which the optical disk is not set;
comparing a play list that corresponds to information stored in the optical disk, a play list of the additive contents downloaded on a disk unit in which the optical disk is not set, and a play list of downloaded additive contents maintained by one own, respectively; and
generating a new play list relating to latest contents among each one of the contents.
